(19) United States
(12) Patent Application Publication
(10) Pub. No.: US 2018/0326782 A1
(43) Pub. Date: Nov. 15, 2018

(54) WHEEL BEARING UNIT

(71) Applicant: Schaeffler Technologies AG & Co. KG, Herzogenaurach (DE)

(72) Inventors: Andreas Becker, Hammelburg (DE); Florian Koniger, Schweinfurt (DE); Alexander Happ, Hofheim (DE)

(73) Assignee: Schaeffler Technologies AG & Co. KG, Herzogenaurach (DE)

(21) Appl. No.: 15/539,406

(22) PCT Filed: Jan. 14, 2016
(86) PCT No.: PCT/DE2016/200009

§ 371 Date: Jun. 23, 2017

(30) Foreign Application Priority Data
Feb. 3, 2015 (DE) 10 2015 201 798.2

(51) Int. Cl. B60B 27/00; B60B 27/02; F16C 19/18

(52) U.S. Cl. CPC B60B 27/0073; F16C 2326/02; B60B 27/0068; B60B 27/0094; B60B 27/02; F16C 19/184; B60B 2900/5112; B60B 2380/12; B60B 2380/73; B60B 2900/5114; B60B 2900/5118; B60B 2900/212; B60B 2360/10; B60B 2360/50; B60B 2900/114; B60B 2310/316; B60B 27/0005

(57) ABSTRACT

The invention relates to a wheel bearing unit including a wheel hub. The wheel hub has an integrally formed wheel flange at one end and an inner ring which can be rotated together with the wheel hub. The inner ring is secured on the wheel hub by a rolling rivet connection in order to pretension a row of rolling elements relative to an outer ring. The wheel bearing unit also has an encoder, which is provided on the inner ring and extends radially in the direction of the outer ring, and a protective cover which is secured to the outer ring in order to close and seal annular openings that are formed between the outer ring and the wheel hub. A cylindrical mounting section of the protective cover is pressed into a cylindrical press-in portion of the outer ring, and a shielding section extends from the cylindrical assembly portion inwards in a radial direction (R1). A base section is provided which adjoins the shielding section in order to cover an inner-side end of the wheel hub, and a sealing element is provided on a circumferential surface, which faces away from the outer ring, of the cylindrical assembly portion. The sealing element is formed such that a part of the sealing element protrudes from the mounting section in the axial direction (R2) in order to form a sealing lip which is pressed axially onto a section of the outer ring in order to sealingly rest against this section.

### FIELD OF THE INVENTION

The invention relates to a wheel bearing unit, especially for motor vehicles.

### BACKGROUND

Roller-riveted wheel bearing units have been used in the past for passenger cars in large numbers. For non-driven wheel bearing units, these are regularly used in connection with vehicle-side covers that can assume a large part of the axial-side sealing function. In connection with wheel bearing units having sensors that can detect or measure, for example, wheel rotational speeds, these cover closures are advantageous. Through such cover closures, it is no longer necessary to provide an additional seal. Covers with mounted sensors are made from a non-magnetic material at least in the sensor area, which is why stainless steel covers are often used.

From DE 11 2011 100 942 T5, a wheel bearing unit with a cover is known in which the cover has one section that is pressed into the vehicle-side end of an outer ring. Between the outer ring and the cover there is an elastic element that is pressed in completely with the cover and is completely deformed elastically.

EP 2 047 131 B1 discloses a wheel bearing unit that provides a cover for sealing the bearing. The cover is mounted with one section on an outer circumferential area of an outer ring.

### SUMMARY

The invention is based on the objective of providing a wheel bearing unit that guarantees a secure sealing of the bearing.

According to the invention, this object is achieved by a wheel bearing unit with a wheel hub, wherein the wheel hub has, on its one end, a wheel flange with an integral construction and an inner ring that can rotate together with the wheel hub, wherein the inner ring is mounted by a roller rivet collar on the wheel hub, in order to pretension a row of roller bodies relative to an outer ring, and with an encoder that is provided on the inner ring and extends radially in the direction of the outer ring and with a protective cover that is fixed on the outer ring, in order to close and seal ring-shaped openings that are formed between the outer ring and the wheel hub, wherein the protective cover is pressed with a cylindrical mounting section into a cylindrical press-in section of the outer ring and a shielding section extends inward in the radial direction from the cylindrical mounting section, and a base section that connects to the shielding section in order to cover an inner-side end of the wheel hub, wherein a sealing element is provided on a circumferential area of the cylindrical mounting section facing away from the outer ring, wherein the sealing element is constructed such that a part of the sealing element projects in the axial direction from the mounting section, in order to form a sealing lip that is pushed axially onto a section of the outer ring, in order to form a sealing contact on this section.

In the wheel bearing unit according to the invention, for sealing the ring-shaped opening between the outer ring and wheel hub there is a protective cover. This protective cover is pressed into the outer ring with a cylindrical mounting section. For improving the sealing effect of the protective cover, a sealing element is provided on a circumferential surface of the mounting section facing away from the outer ring. The sealing element is constructed such that it projects in an axial direction form the mounting section and therefore forms a static sealing lip. For pressing in the mounting section, the sealing lip is pushed axially onto or along a section of the outer ring, in order to form a sealing contact with this section. The area of the sealing element that is provided on the mounting section remains untouched, i.e., this area experiences no elastic deformation when the protective cover is pressed in. Such a configuration allows a secure sealing of the wheel bearing unit and prevents the penetration of rainwater or dust from the outside into the bearing, as well as the discharge of lubricating grease that is provided inside the bearing. Another advantage relative to the prior art is that the attachment of the sealing element according to the invention does not press this element between the mounting section and the outer ring when the protective cover is pressed in, which could have damaged the sealing element. Overall, this arrangement leads to an improvement of the seal and an increase in the service life.

Preferably, the section of the outer ring contacting the sealing element has an inclined construction. This section connects to the cylindrical section of the outer ring on which the mounting section is pressed in. The inclined section makes it possible for the sealing lip to be shifted along the outer ring and to form a sealing contact on this ring. Preferably, the section is constructed such that the individual sections or the entire outer ring can be produced in one processing step or can be subjected to one grinding process. Alternatively, it is also possible to form this section with a radius, a step, or the like.

According to one construction of the invention, the protective cover is formed from a non-ferromagnetic material. In this way, negative effects on the magnetic flux can be prevented.

Preferably, the sealing element is formed from an elastomer and vulcanized onto the mounting section of the protective cover. This guarantees that the sealing element remains in a fixed position.

According to one construction of the invention, the sealing element extends along the protective cover. This means that, in addition to the mounting section, the sealing element is also vulcanized along the other sections of the protective cover. This has the advantage that also a non-ferromagnetic metallic material can be used for forming the protective cover, without this influencing the magnetic flux.

According to one alternative construction of the invention, the base section connects to the shielding section via a cylindrical section. Alternatively, the cylindrical section can also be provided with a radius or have a tapered, inclined, or stepped construction. With reference to this configuration, the protective cover can have an installation-space-saving construction and can be adapted to the wheel bearing unit.

According to one construction of the invention, the protective cover is pressed with the cylindrical mounting section on an inner circumference of the outer ring. Alternatively, the protective cover is pressed with the cylindrical section on an outer circumference of the outer ring. According to the requirement or available installation space, the protective cover is pressed on the inner circumference or on the outer circumference of the outer ring.

Preferably, the protective cover has a shell-like construction formed by pressing. By constructing the protective cover in this way, the rigidity can be increased and deformation due to the appearance of chips, etc., can be prevented.

In one construction of the invention, a rotational speed sensor is provided for detecting the rotational speed of the wheel hub, wherein the rotational speed sensor and the encoder are arranged opposite each other with a predetermined air gap in the axial direction relative to the shielding section.

### BRIEF DESCRIPTION OF THE DRAWINGS

Two embodiments of the invention are described below with reference to three figures. Shown are:

FIG. 1 a longitudinal section through a wheel bearing unit according to the invention according to a first embodiment,

FIG. 2 an enlarged representation of detail I shown in FIG. 1,

FIG. 3 a longitudinal section through a wheel bearing unit according to the invention according to a second embodiment, and

FIG. 4 an enlarged representation of the pressed-in protective cover according to a third embodiment.

### DETAILED DESCRIPTION OF THE PREFERRED EMBODIMENTS

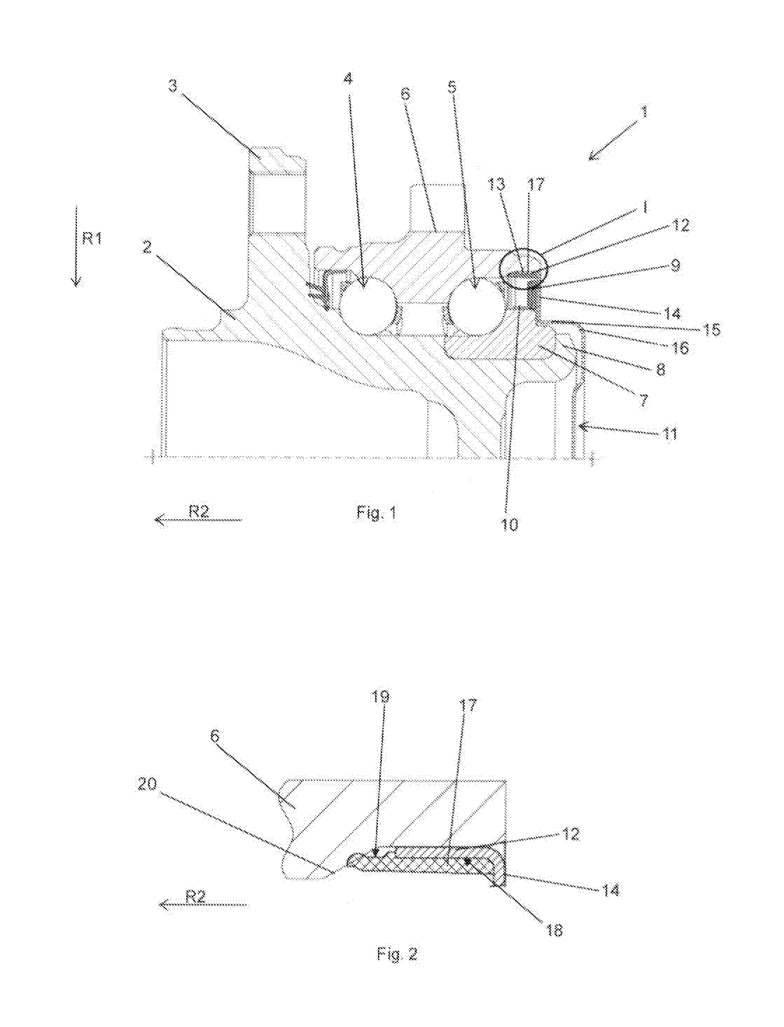

FIG. 1 shows a wheel bearing unit 1 according to a first embodiment that is allocated to a not-shown vehicle wheel. The wheel bearing unit 1 comprises a wheel hub 2 that has, on its one end, a radially oriented wheel flange 3 with a one-piece construction. The wheel bearing arrangement further has two axially spaced apart rows 4, 5 of roller bodies, with these roller bodies being guided on the outside in an outer ring 6. On the inside, the roller bodies of the row 4 of roller bodies are guided directly in a raceway of a wheel hub 2 and the wheel bodies of the row 5 of roller bodies are guided in an inner ring 7 fixed on the wheel hub 2.

The inner ring 7 is mounted axially on the wheel hub 2 by a roller rivet collar 8, whereby the row 5 of roller bodies is pretensioned relative to the outer ring 6.

As can be seen further from FIG. 1, an encoder 9 is arranged on an outer circumference of the inner ring 7. The encoder 9 is provided on a carrier 10 by which the encoder 9 is connected to the outer circumference of the inner ring 7. The encoder 9 is formed of an elastomer material, filled with magnetic particles, and is connected integrally to the carrier 10 by a vulcanization process. In addition to the elastomer material, the encoder 9 can also be formed from a plastic or a hard rubber.

For sealing an opening between the outer ring 6 and the wheel hub 2 there is a protective cap 11 that is press formed from a non-ferromagnetic material. The protective cap 11 is pressed with a cylindrical mounting section 12 onto a cylindrical press-in section 13, the inner circumference of the outer ring 6. A shielding section 14 connects to the cylindrical section 12 inward in a radial direction R1. A base section 16 connects to the shielding section 14 via a cylindrical section 15.

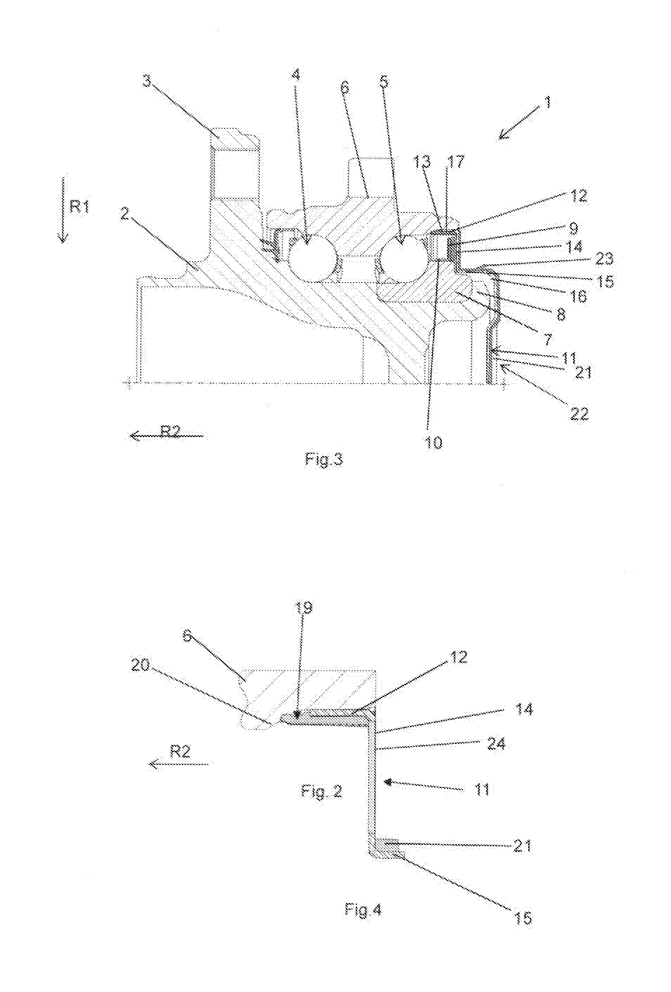

FIG. 2 shows an enlarged representation of detail I shown in FIG. 1, namely an enlarged view of the protective cap 11. As can be seen, the mounting section 12 has a sealing element 17. The sealing element 17 is provided on a circumferential area 18 of the mounting section 12 facing away from the outer ring 6. The sealing element 17 is formed as an elastomer that is vulcanized onto the section.

The sealing element 17 is further constructed such that a part of the sealing element projects in an axial direction R2 from the mounting section 12, in order to form a sealing lip 19. When the mounting section 12 is pressed into the cylindrical section 13, only the area of the sealing lip 19 is pushed axially onto a section 20 of the outer ring 6, in order to form a sealing contact on this section 20. The area of the sealing element 17 that is vulcanized onto the mounting section 12 remains untouched, i.e., it is not elastically deformed.

The section 20 of the outer ring 6 contacting the sealing lip 19 has an inclined construction and connects directly to the press-in section 13.

FIGS. 3 and 4 show the protective cap 11 according to a second and third embodiment. Matching components are provided with identical reference symbols. The following description is therefore largely limited to features that are different.

The protective cap 11 shown in FIG. 3 corresponds in its construction to the protective cap 11 described in FIGS. 1 and 2. In addition to the provision of the sealing element 17 on the mounting section 12, a sealing element 21 extends along the complete end side 22 of the protective cap 11. The end side 22 is the side that is turned away from the wheel bearing unit 1. Furthermore, the sealing element 21 has multiple sealing lips 23.

FIG. 4 shows an enlarged representation of the pressed-in protective cap 11. The wheel bearing unit 1 basically corresponds to the wheel bearing unit 1 shown in FIG. 3. The shielding section 14 of the protective cap 11 has multiple recesses 24 distributed around the circumference. These recesses 24 can be constructed, for example, as elongated holes. In addition, the recess 24 is covered with the sealing element 21 or is closed by this sealing element. Alternatively, it is also possible to leave the area of the recess 24 with the sealing element 21 open.

### LIST OF REFERENCE NUMBERS

1 Wheel bearing unit
2 Wheel hub
3 Wheel flange
4 Row of rolling bodies
5 Row of rolling bodies
6 Outer ring
7 Inner ring
8 Rolling rivet collar
9 Encoder
10 Carrier
11 Protective cover
12 Cylindrical mounting section
13 Press-in section
14 Shielding section
15 Cylindrical section
16 Base section
17 Sealing element
18 Circumferential surface
19 Sealing lip
20 Section of the outer ring
21 Sealing element
22 End side
23 Sealing lip
24 Recess
R1 Radial direction
R2 Axial direction

1. A wheel bearing unit comprising a wheel hub having on one end thereof, an integral wheel flange, an outer ring, a row of rolling bodies, an inner ring that rotates together with the wheel hub, the inner ring is mounted by a rolling rivet collar on the wheel hub and pre-tensions the row of rolling bodies relative to the outer ring, an encoder on the inner ring that extends radially in a direction of the outer ring, a protective cover that is fixed on the outer ring in order to close and seal ring-shaped openings that are formed between the outer ring and the wheel hub, wherein the protective cover is pressed with a cylindrical mounting section in a cylindrical press-in section of the outer ring and a shielding section of the protective cover extends inward in a radial direction (R1) from the cylindrical mounting section, a base section that connects to the shielding section in order to cover an inner end of the wheel hub, a sealing element provided on a circumferential surface facing away from the outer ring in the cylindrical mounting section, the sealing element is constructed such that a part of the sealing element projects in an axial direction (R2) from the mounting section in order to form a sealing lip that is shifted axially onto a section of the outer ring, in order to form a sealing contact with said section.

2. The wheel bearing unit according to claim 1, wherein the section of the outer ring that contacts the sealing lip of the sealing element has a tapered construction.

3. The wheel bearing unit according to claim 1, wherein the protective cover is formed from a non-ferromagnetic material.

4. The wheel bearing unit according to claim 1, wherein the sealing element is formed from an elastomer vulcanized on the mounting section.

5. The wheel bearing unit according to claim 1, wherein the sealing element extends along the protective cover.

6. The wheel bearing unit according to claim 1, wherein the shielding section connects to the base section via a cylindrical section.

7. The wheel bearing unit according to claim 1, wherein the protective cover is pressed with the cylindrical mounting section on an inner circumference of the outer ring.

8. The wheel bearing unit according to claim 1, wherein the protective cover is pressed with the cylindrical mounting section on an outer circumference of the outer ring.

9. The wheel bearing unit according to claim 1, wherein the protective cover is shell-shaped design and is constructed by pressing.

10. The wheel bearing unit according to claim 1, further comprising a rotational speed sensor that detects a rotational speed of the wheel hub, the rotational speed sensor and the encoder are arranged opposite each other with a predetermined air gap in the axial direction by the shielding section.
